(19) United States
(12) Patent Application Publication
(10) Pub. No.: US 2012/0084190 A1
(43) Pub. Date: Apr. 5, 2012

(54) Systems and Methods for Using a Stacker Order in an Electronic Trading Environment

(75) Inventors: Patricia A. Messina, Chicago, IL (US); Bharat Mittal, Schaumburg, IL (US)

(73) Assignee: TRADING TECHNOLOGIES INTERNATIONAL, INC., Chicago, IL (US)

(21) Appl. No.: 12/895,391

(22) Filed: Sep. 30, 2010

(51) Int. Cl. G06Q 40/00; G06Q 90/00

(52) U.S. Cl. 705/37; 705/500

(57) ABSTRACT

A stacker order type is provided for a spread trading strategy. According to an example embodiment, when a stacker order is enter to buy or sell a spread at a desired spread price, a trading tool dynamically determines a plurality of desired spread prices at which to work the spread. To work the multiple desired spread prices, the trading tool may then enter a quoting order for each desired spread price. As leaned on market prices change, one or more of the quoting orders may be re-assigned between the desired spread prices to minimize re-quoting.

### BACKGROUND

The present invention is directed towards electronic trading systems. More particularly, certain embodiments of the present invention are directed towards using a stacker order type for trading strategies, such as a spread between two or more tradeable objects, in electronic trading systems.

An electronic trading system provides for electronically matching orders to buy and sell items to be traded. The items may include, for example, stocks, options, and commodities. Typically, an electronic exchange in the electronic trading system is used to match the orders. In addition, the electronic exchange provides market data to various client devices in the electronic trading system used by traders to place the orders. For example, the electronic exchange may provide market data such as prices for various items available for trading and trade confirmations indicating what trades have occurred at what quantities and/or prices.

In addition to trading single items, a trader may trade more than one item according to a trading strategy. One common trading strategy is a spread between two or more tradeable objects, and trading according to a spread trading strategy may also be referred to as spread trading. Spread trading may attempt to capitalize on changes or movements in the relationships between the items in the trading strategy, for example.

A spread trading strategy may define a relationship between two or more items to be traded, as well as a desired price at which to buy or sell the trading strategy. Each item in the spread trading strategy may be referred to as a leg of the trading strategy. Then, an automated trading tool, for example, attempts to achieve the desired price by buying and selling the legs at appropriate prices. The leg for which the order is placed is referred to as the quoting leg. The other leg is referred to as a lean leg and/or a hedge leg. The price that the quoting leg is quoted is based on a price (often an inside market price) that an order could be filled at in the hedge leg. The price of the hedge leg is also known as the lean price (also referred to as a leaned on price). As the lean price changes, the quoting price may also need to change to achieve a desired spread price.

Electronic exchanges have made it possible for an increasing number of people to actively participate in a market at any given time. The increase in the number of potential market participants has advantageously led to, among other things, a more competitive market and greater liquidity. In a competitive environment, like electronic trading, where every second or a fraction of second counts in intercepting trading opportunities, it is desirable to offer tools that play a role in offering a competitive edge.

### SUMMARY

Different embodiments that are described herein include systems and methods for trading a spread trading strategy in an electronic trading environment.

Traders implement various trading strategies to succeed in the competitive trading environment. Some traders may wish to buy or sell a spread at multiple spread prices to achieve a desired average price for the spread. According to an example embodiment, a stacker order type allows a trader to work multiple desired spread prices for a spread trading strategy while a single spread price is identified by the trader.

When a trader enters a stacker order, a trader may identify a desired spread price for a spread. Then, a trading tool may dynamically determine a plurality of desired spread prices at which to work the spread. The plurality of desired spread prices may be determined based on the identified spread price and based on various parameters preconfigured for the stacker order, such as a number of price levels and an offset between each price level. To work the multiple spread prices, the trading tool will enter a quoting order for each spread price. Additionally, the trading tool may assign each quoting order to its respective spread price. As the leaned on price changes for the spread, the quoting orders may have to be re-priced. According to an example embodiment, the pending quoting orders may be re-assigned between the desired spread prices of the stacker order to minimize re-quoting.

### BRIEF DESCRIPTION OF THE DRAWINGS

Example embodiments are described herein with reference to the following drawings.

FIG. 1 illustrates an electronic trading system in which certain embodiments may be employed;

FIG. 2 illustrates an electronic trading system in which certain embodiments of may be employed;

FIG. 3 illustrates a block diagram of a trading strategy which may be employed with certain embodiments;

FIG. 4 illustrates a block diagram of a stacker order configuration window that can be used to configure and/or send stacker orders;

FIG. 5 illustrates a flow diagram of a method for placement of a stacker order according to one embodiment;

FIG. 6 illustrates a flow diagram of a method for re-pricing a spread leg order of a stacker order according to one embodiment;

FIG. 7 illustrates an example trading interface;

FIG. 8 illustrates three trading interface that are used to illustrate placement of a stacker order and quoting orders;

FIG. 9 illustrates three trading interfaces that are used to illustrate re-assignment of quoting orders between a number of desired spread prices;

FIG. 10 illustrates three trading interface that are used to illustrate a fill of one of the quoting orders;

FIG. 11 illustrates three trading interface that are used to illustrate a partial fill of one of the quoting orders; and

FIG. 12 illustrates three trading interfaces that are used to illustrate quantity adjustment of one of the pending quoting orders upon re-assignment.

The foregoing summary, as well as the following detailed description, will be better understood when read in conjunction with the drawings which show certain embodiments of the present invention. The drawings are for the purpose of illustrating certain embodiments, but it should be understood that the present invention is not limited to the arrangements and instrumentality shown in the drawings.

### DETAILED DESCRIPTION

Certain embodiments of the present invention provide a stacker order type that can be used in relation to a trading strategy, such as a spread strategy. According to an example embodiment, when a trader places a stacker order at a desired spread price for a spread strategy, a trading tool will automatically generate and work multiple desired spread prices, e.g., multiple spread orders, for the spread strategy. More specifically, when a stacker order is entered, the trading tool will identify a plurality of desired spread prices for the spread trading strategy. To work the multiple desired spread prices, the trading tool will then enter a quoting order for each identified spread price. It should be understood that the trading tool may quote one or more legs of the spread strategy. According to an example embodiment, the trading tool assigns each quoting order to its respective desired spread price. As the leaned on price changes for the spread trading strategy, one or more of the quoting orders may have to be re-priced. According to an example embodiment, one or more of the pending quoting orders may be re-assigned to different desired spread prices associated with the stacker order to minimize re-quoting. The trading tool continues execution of the stacker order until all desired spread prices are executed or until a predefined condition is detected, such as a cancellation of the stacker order.

As will be described in greater detail below, there are many advantages of using a stacker order type described herein. First, a trader may work multiple trading strategies, such as spreads, each at a different spread price, while identifying a single desired spread price. Second, a trader may maintain a more advantageous queue position for the quoting orders as they are re-quoted. Other advantages are apparent as well upon reading the description herein.

### I. Example Electronic Trading System

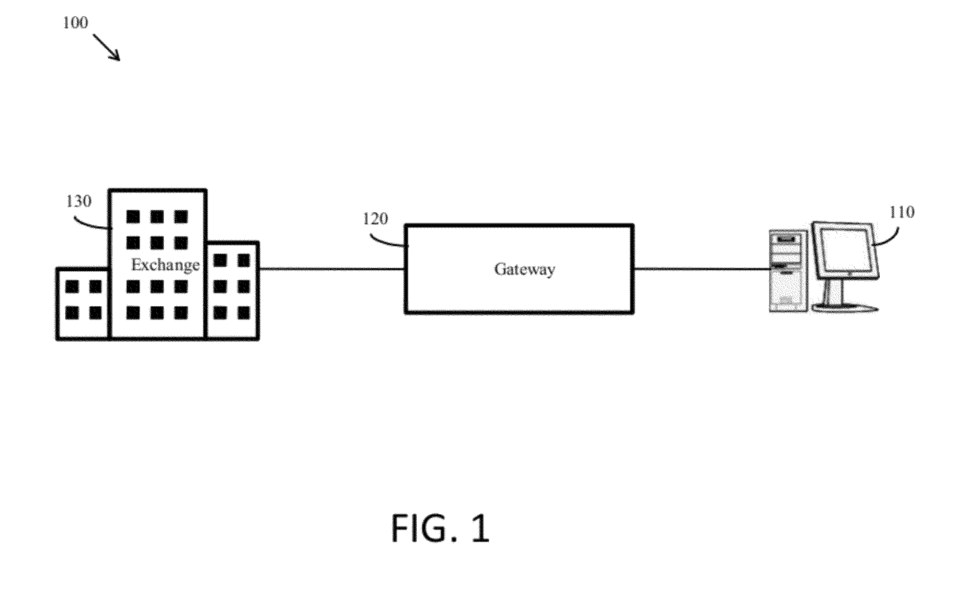

FIG. 1 illustrates an electronic trading system 100 in which certain embodiments of the present invention may be employed. The system 100 includes a client device 110, a gateway 120, and an electronic exchange 130. The client device 110 is in communication with the gateway 120. The gateway 120 is in communication with the exchange 130.

In operation, the client device 110 may be utilized by a user to send orders to buy or sell tradeable objects at the exchange 130. The orders are sent through the gateway 120 to the exchange 130. In addition, market data is sent from the exchange 130 through the gateway 120 to the client device 110. The user may also utilize the client device 110 to monitor this market data and base a decision to send an order for a tradeable object on the market data.

A tradeable object is anything which can be traded with a quantity and/or a price. For example, financial products such as stocks, options, bonds, futures, currency, warrants, funds derivatives, commodities, traded events, goods, and collections and/or combinations of these may be tradeable objects. A tradeable object may be “real” or “synthetic.” A real tradeable object includes products that are listed by an exchange. A synthetic tradeable object includes products that are defined by the user and are not listed by an exchange. For example, a synthetic tradeable object may include a combination of real (or other synthetic) products such as a synthetic spread created by a trader utilizing a client device 110.

The client device 110 may include one or more electronic computing platforms such as a hand-held device, laptop, desktop computer, workstation with a single or multi-core processor, server with multiple processors, and/or cluster of computers, for example.

The client device 110 may include one or more trading applications. The trading application(s) may process market data by arranging and displaying the market data in trading and charting windows. This processing may be based on user preferences. The trading application(s) may include an automated trading tool such as an automated spread trading tool to process spread orders.

The client device 110 may include an electronic trading workstation, a portable trading device, an algorithmic trading or “black-box” system, an embedded trading system, and/or an automated trading tool, for example. The client device 110 may be a computing system running a copy of X_TRADER™, an electronic trading platform provided by Trading Technologies International, Inc. of Chicago, Ill. As another example, the client device 110 may be a computing device running the automated trading tool, Autospreader™, also provided by Trading Technologies International, Inc.

The client device 110 is adapted to send orders to buy or sell tradeable objects. The client device 110 may also be adapted to cancel orders, change orders, and/or query an exchange.

The orders sent by the client device 110 may be sent at the request from a user or automatically from the computer. For example, a trader may utilize an electronic trading workstation to place an order for a particular tradeable object, manually providing various parameters for the order such as an order price and/or quantity. As another example, an automated trading tool may calculate one or more parameters for an order and automatically send the order. In some instances, an automated trading tool may prepare the order to be sent but not actually send it without confirmation from the user.

In certain embodiments, the client device 110 includes a user interface. The user interface may include one or more display devices for presenting a text-based or graphical interface of a trading application to a user. For example, the display devices may include computer monitors, hand-held device displays, projectors, and/or televisions. The user interface may be used by the user to specify or review parameters for an order using a trading application. The user interface may include one or more input devices for receiving inputs from a user, for example. The input devices may include a keyboard, trackball, two or three-button mouse, and/or touch screen. The user interface may include other devices for interacting with a user, and information may be aurally provided to a user through a speaker and/or received through a microphone.

In certain embodiments, the orders from the client device 110 are sent to the exchange 130 through the gateway 120. The client device 110 may communicate with the gateway 120 using a local area network, a wide area network, a virtual private network, a T1 line, a T3 line, an ISDN line, a point-of-presence, and/or the Internet, as well as different connection types.

The gateway 120 is adapted to communicate with the client device 110 and the exchange 130. The gateway 120 facilitates communication between the client device 110 and the exchange 130. For example, the gateway 120 may receive orders from the client device 110 and transmit the orders to the exchange 130. As another example, the gateway 120 may receive market data from the exchange 130 and transmit the market data to the client device 110.

In certain embodiments, the gateway 120 performs processing on data communicated between the client device 110 and the exchange 130. For example, the gateway 120 may process an order received from the client device 110 into a data format acceptable by the exchange 130. Similarly, the gateway 120 may transform market data in an exchange-specific format received from the exchange 130 into a format understood by the client device 110. The processing of the gateway 120 may also include tracking orders from the client device 110 and updating the status of the order based on fill confirmations received from the exchange 130. As another example, the gateway 120 may coalesce market data from the exchange 130 and provide it to the client device 120.

In certain embodiments, the gateway 120 provides services other than processing data communicated between the client device 110 and the exchange 130. For example, the gateway 120 may provide risk processing.

The gateway 120 may include one or more electronic computing platforms such as a hand-held device, laptop, desktop computer, workstation with a single or multi-core processor, server with multiple processors, and/or cluster of computers.

The gateway 120 may include one or more gateway applications. The gateway application(s) may, for example, handle order processing and market data processing. This processing may be based on user preferences.

In certain embodiments, the gateway 120 communicates with the exchange 130 using a local area network, a wide area network, a virtual private network, a T1 line, a T3 line, an ISDN line, a point-of-presence, and/or the Internet, or other connection types.

The exchange 130 is adapted to match orders to buy and sell tradeable objects. The tradeable objects may be listed for trading by the exchange 130. The orders may include orders received from the client device 110, for example. Orders may be received from the client device 110 through the gateway 120. In addition, the orders may be received from other devices in communication with the exchange 130. That is, typically the exchange 130 will be in communication with a variety of other client devices (which may be similar to client device 110) that also provide orders to be matched.

The exchange 130 is adapted to provide market data. The market data may be provided to the client device 110 through the gateway 120. The market data may include data that represents the inside market, for example. The inside market is the lowest sell price (also referred to as the “best ask”) and the highest buy price (also referred to as the “best bid”) at a particular point in time. The market data may also include market depth. Market depth refers to the quantities available at the inside market and may also refer to quantities available at other prices away from the inside market. Thus, the inside market may be considered the first level of market depth. One tick away from the inside market may be considered the second level of market depth, for example. In certain embodiments, market depth is provided for all price levels. In certain embodiments, market depth is provided for less than all price levels. For example, market depth may be provided only for the first five price levels on either side of the inside market. The market data may also include information such as the last traded price (LTP), the last traded quantity (LTQ), and order fill information.

In certain embodiments, the system 100 includes more than one client device 110. For example, multiple client devices similar to the client device 110, discussed above, may be in communication with the gateway 120 to send orders to the exchange 130.

In certain embodiments, the system 100 includes more than one gateway 120. Multiple gateways similar to the gateway 120, discussed above, may be in communication with the client device 110 and the exchange 130. Such an arrangement may be used to provide redundancy should one gateway 120 fail, for example.

In certain embodiments, the system 100 includes more than one exchange 130. The gateway 120 may be in communication with multiple exchanges similar to the exchange 130, discussed above. Such an arrangement may allow the client device 110 to trade at more than one exchange through the gateway 120, for example. Alternatively, multiple gateways could be used, with each gateway assigned to a specific exchange.

In certain embodiments, the client device 110 includes one or more computing devices or processing components. In other words, the functionality of the client device 110 may be performed by more than one computing device. For example, one computing device may generate orders to be sent to the exchange 130 while another computing device may provide a graphical user interface to a trader. In certain embodiments, the gateway 120 includes one or more computing devices or processing components. In other words, the functionality of the gateway 120 may be performed by more than one computing device. In certain embodiments, the exchange 130 includes one or more computing devices or processing components. In other words, the functionality of the exchange 130 may be performed by more than one computing device.

In certain embodiments, the gateway 120 is part of the client device 110, and the components of the gateway 120 may be part of the same computing platform as the client device 110. As another example, the functionality of the gateway 120 may be performed by components of the client device 110. In certain embodiments, the gateway 120 is not present. Such an arrangement may occur when the client device 110 does not need to utilize the gateway 120 to communicate with the exchange 130, such as when the client device 110 has been adapted to communicate directly with the exchange 130.

In certain embodiments, the gateway 120 is physically located at the same site as the client device 110. In certain embodiments, the gateway 120 is physically located at the same site as the exchange 130. In certain embodiments, the client device 110 is physically located at the same site as the exchange 130. In certain embodiments, the gateway 120 is physically located at a site separate from both the client device 110 and the exchange 130.

While not shown for the sake of clarity, in certain embodiments, the system 100 may include other devices that are specific to the communications architecture such as middleware, firewalls, hubs, switches, routers, exchange-specific communication equipment, modems, security managers, and/or encryption/decryption devices.

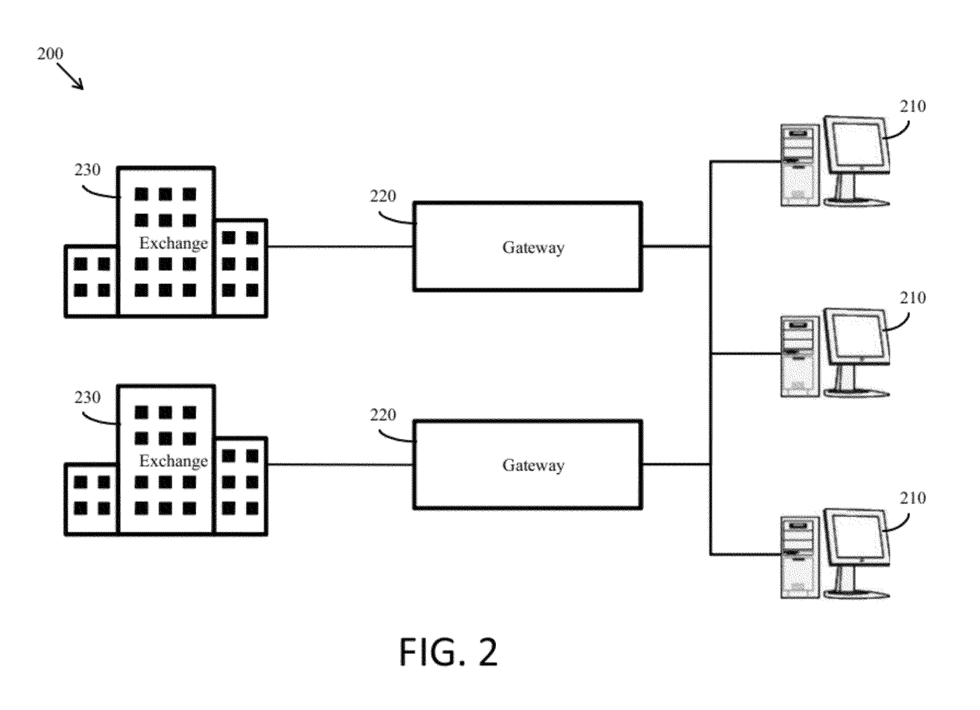

FIG. 2 illustrates an electronic trading system 200 in which certain embodiments of the present invention may be employed. The system 200 includes one or more client devices 210, one or more gateways 220, and one or more electronic exchanges 230. The client devices 210 are in communication with one or more of the gateways 220. Each gateway 220 is in communication with a corresponding exchange 230.

One or more of the client devices 210 may be similar to the client device 110, discussed above, for example. One or more of the gateways 220 may be similar to the gateway 120, discussed above, for example. One or more of the exchanges 230 may be similar to the exchange 130, discussed above, for example.

In operation, a client device 210 may be utilized by a user to send orders to buy or sell tradeable objects listed at different exchanges 230. The orders are sent through one or more of the gateways 220 to one or more of the exchanges 230. In addition, market data is sent from the exchanges 230 through the gateways 220 to one or more of the client devices 210. The user may also utilize a client device 210 to monitor this market data and base a decision to send an order for a tradeable object on the market data.

In certain embodiments, a client device 210 is in communication with one of the gateways 220. In certain embodiments, a client device 210 is in communication with more than one of the exchanges 230.

In certain embodiments, a gateway 220 is in communication with one of the exchanges 230. In certain embodiments, a gateway 220 is in communication with more than one of the exchanges 230.

In certain embodiments, a client device 210 is adapted to communicate directly with one or more of the exchanges 230 and does not utilize a gateway 220.

The components, elements, and/or functionality of the systems 100 and/or 200 discussed above may be implemented alone or in combination in various forms in hardware, firmware, and/or as a set of instructions in software, for example. Certain embodiments may be provided as a set of instructions residing on a computer-readable medium, such as a memory, hard disk, CD-ROM, DVD, and/or EPROM, for execution on a general purpose computer or other processing device.

### II. Strategy Trading

As mentioned above, in addition to trading a single tradeable object by itself, a trader may trade more than one tradeable object according to a trading strategy. One common trading strategy is a spread. Trading a spread, or “spread trading,” attempts to capitalize on changes or movements in the relationships between the tradeable object in the trading strategy, for example.

A trader may utilize an automated trading tool to trade according to a trading strategy. An automated trading tool application may be located at various devices, such as a client device, or a gateway, or a combination of various devices such that different components of the trading application are located at more than one computer device. For example, the automated trading tool may be Autospreader™ provided by Trading Technologies International, Inc. of Chicago, Ill.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for leg A and selling one unit of a second tradeable object for leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for leg A and selling 3 units of a second tradeable object for leg B. The sign of the spread ratio may be used to indicate whether the leg is to be bought (the spread ratio is positive) or sold (the spread ratio is negative) when buying the trading strategy. In the example above, the spread ratio associated with leg A would be “2” and the spread ratio associated with leg B would be “−3.”

In some instances, the spread ratio may be implied or implicit. For example, the spread ratio for a leg of a trading strategy may not be explicitly specified, but rather implied or defaulted to be “1” or “−1.”

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with leg A may be “2” and the multiplier associated with leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

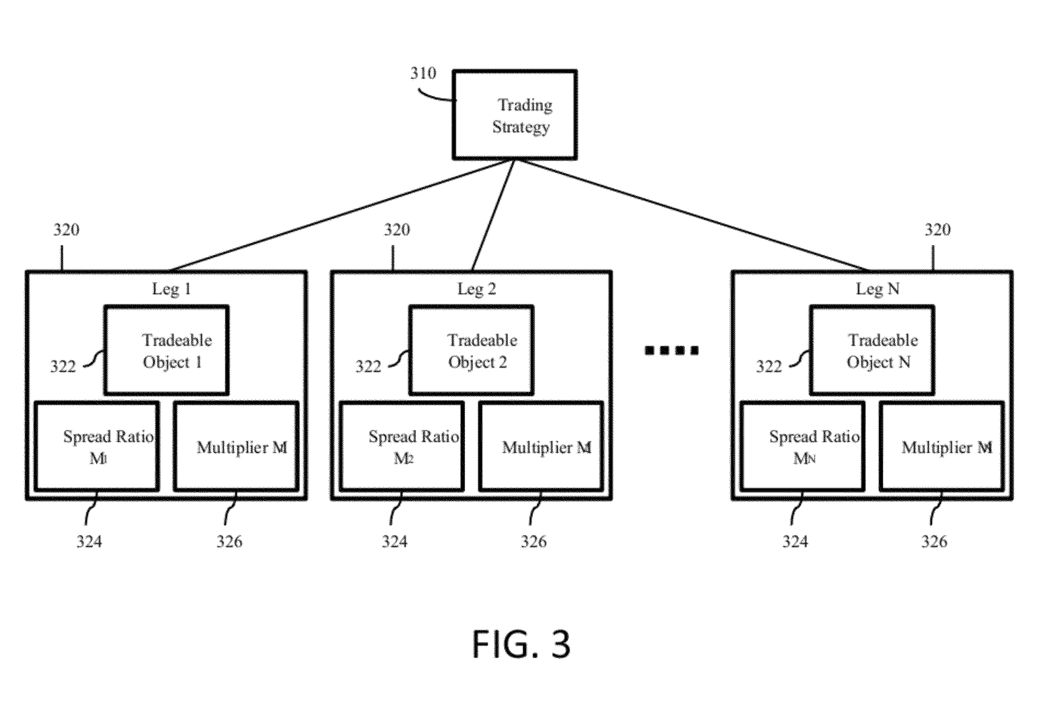

FIG. 3 illustrates a block diagram of a trading strategy 310 which may be employed by certain embodiments of the present invention. The trading strategy 310 includes “N” legs 320. The trading strategy 310 defines the relationship between the tradeable objects 322 for each of the legs 320 using the spread ratios 324 and multipliers 326 associated with each of the legs 320.

Once defined, the tradeable objects 322 in the trading strategy 310 may then be traded together according to the defined relationship. For example, assume that the trading strategy 310 is a spread with two legs 320. Leg 1 is for tradeable object A and Leg 2 is for tradeable object B. In addition, assume that the spread ratios 324 and multipliers 326 associated with Legs 1 and 2 are “1” and “−1,” respectively. That is, the spread 310 is defined such that when the spread 310 is bought, 1 unit of tradeable object A is bought (positive spread ratio, same direction as the spread) and 1 unit of tradeable object B is sold (negative spread ratio, opposite direction of the spread). As mentioned above, typically in spread trading the opposite of the definition applies. That is, when the definition for the spread 310 is such that when the spread 310 is sold, 1 unit of tradeable object A is sold (positive spread ratio, same direction as the spread) and 1 unit of tradeable object B is bought (negative spread ratio, opposite direction of the spread).

The price for the trading strategy 310 is determined based on the definition. In particular, the price for the trading strategy 310 is typically the sum of price of the tradeable object 322 multiplied by the multiplier 326 for each of the legs 320 of the trading strategy 310. This is illustrated in Equation 1:

Strategy Price=Σᵢ₌^{N}Multi(i)*Price(i) Eq. 1

Mult(i) is the multiplier associated with leg i and Price(i) is the price for the tradeable object for leg i. The price for a trading strategy may be affected by price tick rounding and/or pay-up ticks. However, both of these implementation details are beyond the scope of this discussion and are well-known in the art.

The discussion above applies whether the example spread is real or synthetic. Recall that, as discussed above, a real spread would be listed at an exchange, such as exchange 130 and/or 230, as tradeable product. In contrast, a synthetic spread would not be listed as a product at an exchange, but rather the various legs of the spread are traded at one or more exchanges. For the purposes of the following discussion, the trading strategy 310 is discussed as a synthetic trading strategy. However, similar techniques to those discussed below may also be applied when a real spread is being traded.

Continuing the example from above, if a trader believes that tradeable object A typically has a price 10 greater than tradeable object B, then the trader may want to buy the spread whenever the difference in price between tradeable objects A and B is less than 10 and sell the spread whenever the difference is greater than 10. As an example, assume that tradeable object A is at a price of 45 and tradeable object B is at a price of 40. The current spread price, using Equation 1, would then be (1)(45)+(−1)(40)=5, which is less than the typical spread of 10. Thus, the trader may buy 1 unit of the spread, which results in buying 1 unit of tradeable object A at a price of 45 and selling 1 unit of tradeable object B at 40. At some later time, the typical price difference may be restored and the price of tradeable object A is 42 and the price of tradeable object B is 32. At this point, the price of the spread is now 10. If the trader sells 1 unit of the spread to close out his position (that is, sells 1 unit of tradeable object A and buys 1 unit of tradeable object B), he has made a profit on the total transaction. In particular, while the trader bought tradeable object A at a price of 45 and sold at 42, losing 3, the trader sold tradeable object B at a price of 40 and bought at 32, for a profit of 8. Thus, the trader made 5 on the buying and selling of the spread.

The above example assumes that there is sufficient liquidity and stability that the tradeable objects can be bought and sold at the market price at approximately the desired times. This allows the trader to achieve the desired price for the spread 310. However, more generally, a trader determines a desired price at which to buy or sell a particular trading strategy. Then, an automated trading tool, for example, attempts to achieve that desired price by buying and selling the legs at appropriate prices. For example, when a trader enters an order to buy or sell the trading strategy 310 at a desired price, the automated trading tool may automatically place an order (also referred to as quoting an order) for one of the tradeable objects 322 of the trading strategy 310 to achieve the desired price for the trading strategy (also referred to as a desired strategy price, desired spread price, and/or a target price).

The leg for which the order is placed is referred to as the quoting leg. The other leg is referred to as a lean leg and/or a hedge leg. The price that the quoting leg is quoted at may be based on the best price that an order could be filled at in the hedge leg. The best price is typically the best bid price when selling and the best ask price when buying. The best price in the hedge leg is also known as the leaned on price, lean price, or lean level. As the leaned on price changes, the price for the order in the quoting leg may also change in order to maintain the desired strategy price. It should be understood that the leaned on price could also be set to a price other than the inside market price. When the quoting leg is filled, the automated trading tool may then submit an order in the hedge leg to complete the strategy. This order may be referred to as an offsetting or hedging order and is typically quoted at the leaned on price. If the order at the leaned on price is not filled (or filled sufficiently to achieve the desired strategy price), then the trader is said to be “legged up” because the trader has not achieved the desired strategy relationship according to the trading strategy definition.

Also, depending on the trading strategy, the price of a quoted leg may be based on less than all of the other legs, for example. As another example, the order parameters of an order in a quoted leg may lean on other types of market conditions in the other legs such as the last traded price (LTP), the last traded quantity (LTQ), a theoretical value, multiple quantities such as quantities closer to the inside market, or some other reference point.

In addition to having a single quoting leg, as discussed above, a trading strategy may be quoted in multiple (or even all) legs. In such situations, each quoted leg still leans on the other legs. When one of the quoted legs is filled, the orders in the other quoted legs are typically cancelled and then appropriate hedge orders are placed based on the leaned on prices that the filled leg was based on.

A trading strategy with more than two legs is known as a multi-legged strategy or a multi-legged spread. In a multi-legged strategy, multiple sets of hedge prices can be chosen from to maintain the defined relationship of the trading strategy for a particular quoted leg.

### III. Stacker Order

Certain embodiments described herein provide a stacker order type that can be used by a trader to work a spread trading strategy at a plurality of desired spread prices. For example, a stacker order may be useful when a trader wishes to achieve a certain average price for a spread trading strategy. Using a stacker order type described herein, once a desired spread price is identified for a stacker order, a trading tool will identify and work multiple desired spread prices, e.g., multiple spreads, at the same time based on the stacker order configuration. While the discussion below focuses on applying a stacker order type to a spread trading strategy, it is understood that the disclosed principles could be applied to different types of trading strategies as well.

According to an example embodiment, when a trader enters a stacker order at a price to buy or sell a spread trading strategy, a plurality of quoting orders are submitted to work a plurality of desired spread prices determined for the stacker order. A trading tool may then assign each quoting order to the corresponding desired spread price. As will be described in greater detail below, when market conditions change such that the quoting orders need to be re-priced, the quoting orders may be re-assigned between the plurality of spread prices, depending on which quoting order satisfies one of the desired spread prices. Such an embodiment allows for fewer order re-quoting and a better queue position for the re-priced orders.

A. Example Stacker Order Configuration/Order Ticket Window

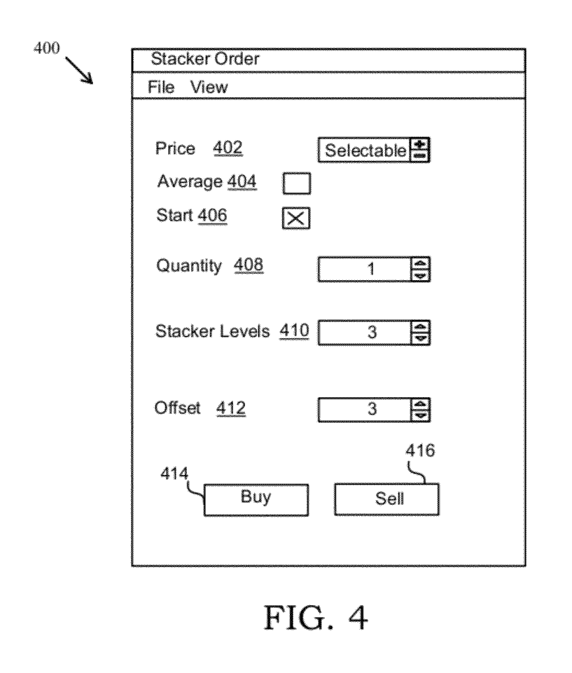

FIG. 4 is a block diagram illustrating an example stacker order setup configuration window 400 that can be used by a trader to configure and/or send stacker orders. The configuration window 400 is user configurable, and a user could save one or more different configurations of various stacker orders. The pre-configured stacker orders could be activated based on different user inputs, such as by selecting a predefined key to activate a desired stacker order. Additionally, as will be described in greater detail below, different order mechanisms could be used as well, such as submitting a stacker order directly through a market depth trading interface.

The configuration window 400 includes a price field 402 that can be used to define a price for the stacker order to be used in relation to a spread trading strategy. According to one example, a trader can enter a stacker order directly via a trading interface by selecting a price from the trading interface. In such an embodiment, the price field 402 may be populated with “selectable,” by default. Alternatively, a user could enter a specific price value via the price field 402. A user could adjust the price value using the plus and minus buttons. Also, the value in the price field 402 can be automatically populated based on a predefined formula. For example, if a user wishes to achieve a certain average price for a spread, a formula could be used to determine a starting price for a stacker order. Additionally, a user could specify all prices at which to work the spread using the stacker order.

It should be understood that various risk mechanisms could also be used to ensure that the spread submission does not cross the market. For example, if a current best bid for a spread is at 99 and a price entered in the price field 402 is 100, the “Buy” button 414 could be disabled to prevent a user from entering an order that would cross the current market. A predetermined selection input, such as selection of a predetermined key, could override such a limitation.

As shown in FIG. 4, a user could also define whether the specified price is an average price 404 or a start price 406. If the average price 404 is selected, the specified price is used as an average price that a trader wishes to achieve in relation to a spread trading strategy using a stacker order. In such an embodiment, desired spread prices may be computed based on the desired average price. If the start price 406 is selected, a trading tool may identify and work a plurality of spread prices for a spread, with the specified price corresponding to highest spread price when the spread is being bought, or to the lowest spread price when the spread is being sold.

A quantity field 408 defines a desired quantity for a stacker order. According to one example embodiment, the specified quantity may be used in relation to each desired spread price identified for the stacker order. A user could adjust the quantity value using the plus and minus buttons. Alternatively, the quantity value could be determined by a formula linked to the quantity field. In such an embodiment, the quantity value could be automatically populated in the quantity field 404. Additionally, while the examples provided herein use the same order quantity for each desired spread price being worked for the spread, it should be understood that a different quantity could be used in relation to each spread price as well.

According to yet another example, rather than specifying the quantity for each spread of the stacker order, the entered quantity could correspond to the total order quantity for the spread trading strategy. In such an embodiment, if a user enters a total quantity of “12,” and specifies “3” levels for a stacker order, a trading tool will determine three spread prices to be worked in relation to the trading strategy. Additionally, the quantity of “4” will be used in relation to each spread price.

Further alternatively, the entered quantity may define a maximum order quantity to be used in relation to each spread price of the stacker order. In such an embodiment, the maximum quantity may be used to determine a number of price levels to be worked for a spread trading strategy when a stacker order is entered. For example, if the maximum order quantity is set to “2,” and a user enters a stacker order to buy or sell a quantity of “6,” the system may determine that the spread is to be worked at three spread price levels, with each price level working a quantity of “2” for the spread.

A stack level field 410 is used to define a number of price levels at which to work a spread when a stacker order is entered. A user could adjust the number in the field 410 using the plus and minus buttons. Additionally, the number of levels could be determined by a formula.

An offset field 412 is used to define an offset value between two consecutive spread prices. According to one example embodiment, the offset value could be defined in terms of ticks, i.e., the smallest price increment. Alternatively, the offset value could be determined by a formula, and the offset field 412 could be automatically populated by the value calculated using the formula. It should be understood that the formula could use a number of variables based on market related data and/or trader related data, for example.

According to one example embodiment, the offset of “1” may be used as a default value such as the spread prices are consecutive. However, different values could be used as well, such that the desired spread prices are not consecutive. Also, it should be understood that two or more offset values could be used in relation to a single stacker order, such that one offset is used in relation to some spread price levels of a stacker order, while a different offset could be used in relation to other spread price levels. In such an embodiment, a user could specify which price levels should be determined using each respective offset.

According to one example embodiment, the configuration window 400 may also function as an order ticket window to allow a trader to submit a pre-configured stacker order to the market directly through the window 400. In such an embodiment, the configuration window 400 could also indicate the current state of the market corresponding to a spread trading strategy, such as the best bid price, the best ask price, and the last traded price. A number of fields could be provided in the configuration window 400 to convey such information (not shown in FIG. 4). The values in such fields could be automatically populated from an application that computes spread data based on market data corresponding to a tradeable object of each leg defined for the spread.

When the window 400 is used by a trader to submit a pre-configured stacker order for a spread trading strategy, the trader could select a “BUY” icon 414 if the trader wishes to buy a spread trading strategy using a stacker order, or a “SELL” icon 416 if the trader wishes to sell the spread trading strategy. It should be understood that the window 400 could also include additional selection options and is not limited to the illustrated parameters. For example, additional configurable options may include slop fields that could be used by a trader to define parameters controlling re-quoting of leg orders associated with a stacker order (not shown in FIG. 4). It should be understood that a separate window, such as a spread configuration window, could be used to define spread related parameters, such as pay-up ticks or slop values, to be used for a specific spread.

B. Placement of a Stacker Order

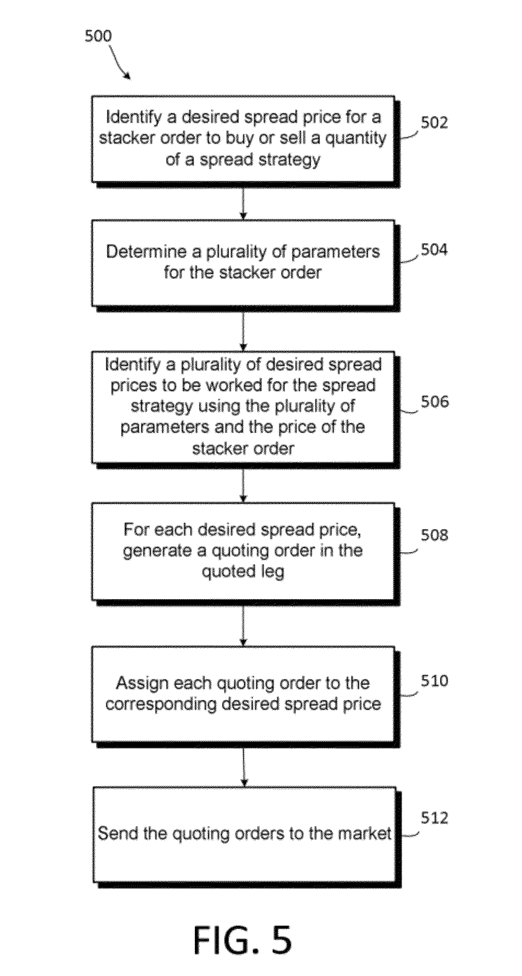

FIG. 5 is a flow diagram illustrating an example method 500 for placement of a stacker order according to an example embodiment. It should be understood that each block in this and each subsequent flow diagrams may represent a module, segment or portion of code, which includes one or more executable instructions for implementing specific logical functions or steps in the process. Alternate implementations are included within the scope of the example embodiments in which functions may be executed out of order from that shown or discussed, including substantially concurrently or in reverse order, depending on the functionality involved, as would be understood by those reasonably skilled in the art of present invention.

The example method 500 is described in relation to a spread trading strategy having two legs. However, the method similarly applies to a trading strategy involving more than two legs. Also, it is assumed that various parameters are predefined for a stacker order, such as shown in FIG. 4, prior to execution of the method 500. Additionally, it is assumed that the spread is configured to quote a single leg of the spread, i.e., “a first leg,” as used herein. However, it should be understood that both legs could be quoted at the same time as well. In such an embodiment, some parts of the method, such as steps 508-512 apply to each quoted leg.

At step 502, a trading tool identifies a price for a stacker order to buy or sell a quantity of a spread trading strategy. According to an example embodiment, the price and quantity of the stacker order may be identified when a trader enters the stacker order. As described above, a user could enter a stacker order via an order ticket, such as the window described in relation to FIG. 4, or via a trading interface that displays market information related to a spread trading strategy, as will be described in greater detail below.

At step 504, the trading tool may determine a plurality of parameters predefined for the stacker order. The parameters of the stacker order may include a number of levels to be used for the stacker order and offset parameters described above.

At step 506, the trading tool identifies a plurality of spread prices to be worked for the spread trading strategy based on the price identified for the stacker order and the plurality of parameters preconfigured for the stacker order. For example, if the stacker order has “N” levels, the trading tool will work the spread trading strategy at “N” desired spread prices. According to an example embodiment, the first desired spread price of “N” prices may be equal to the price specified for the stacker order. Then, the remaining “N−1” desired spread prices may be determined based on the offset value(s). For example, if a stacker order having “3” levels and an offset of “1” is entered to buy a spread trading strategy at the price of “100,” the trading tool may identify that a trader wishes to work the trading strategy at desired spread prices of “100,” “99” and “98.” Similarly, if a stacker order is entered to sell a spread trading strategy at the price of “100,” the trading tool may identify that a trader wishes to work the trading strategy at “100,” “101,” and “102,” assuming the same stacker order configuration. As explained above, a quantity to be used in relation to each spread price may be determined based on a quantity specified for the stacker order.

At step 508, for each desired spread price to be worked for the spread trading strategy, the trading tool generates a quoting order in the first leg of the spread. Each quoting order has a price and a quantity. The price of each quoting order is determined based on the corresponding desired spread price and further based on market conditions in the second leg of the spread. The quantity of each quoting order is determined based on the quantity of the stacker order and a spread ratio defined for the spread. It should be understood that the spread trading strategy could be configured to simultaneously quote more than one leg. In such an embodiment, the trading tool could determine prices and quantities for quoting orders to be submitted in additional legs.

At step 510, the trading tool assigns each quoting order to the corresponding spread order price of the spread trading strategy. At step 512, the trading tool sends the quoting orders to the electronic exchange.

C. Re-Pricing Quoting Leg Orders

The trading tool will work the quoting orders in the market at the multiple spread prices of the spread trading strategy until the trading strategy is executed at the plurality of desired spread prices, or until a predetermined condition is detected. For example, the predetermined condition may be detected when a user deletes the stacker order. It should be understood that when one of the quoting orders is filled corresponding to one of the desired spread, an offsetting order is submitted to one or more other legs of the spread trading strategy. Once the offsetting order(s) are filled, the spread strategy at the corresponding desired spread price is considered executed. According to yet another example embodiment, it should be understood that once the quoting orders are entered, a trader may modify the stacker order by deleting one or more quoting orders of the stacker order. Once some of the quoting orders are deleted, the trading tool will work the remaining quoting orders until the trading strategy is executed at the remaining spread prices, or until a predetermined condition is detected.

As mentioned above, when market conditions corresponding to the leaned on price change, the automatic trading tool may have to re-price all or some of the quoting orders to new prices to achieve the desired spread prices that are worked for the spread trading strategy. According to an example embodiment, rather than placing a new quoting order at the re-calculated quoting price for each desired spread price, the trading tool may re-assign the pending quoting orders between the desired spread prices based on the re-calculated prices.

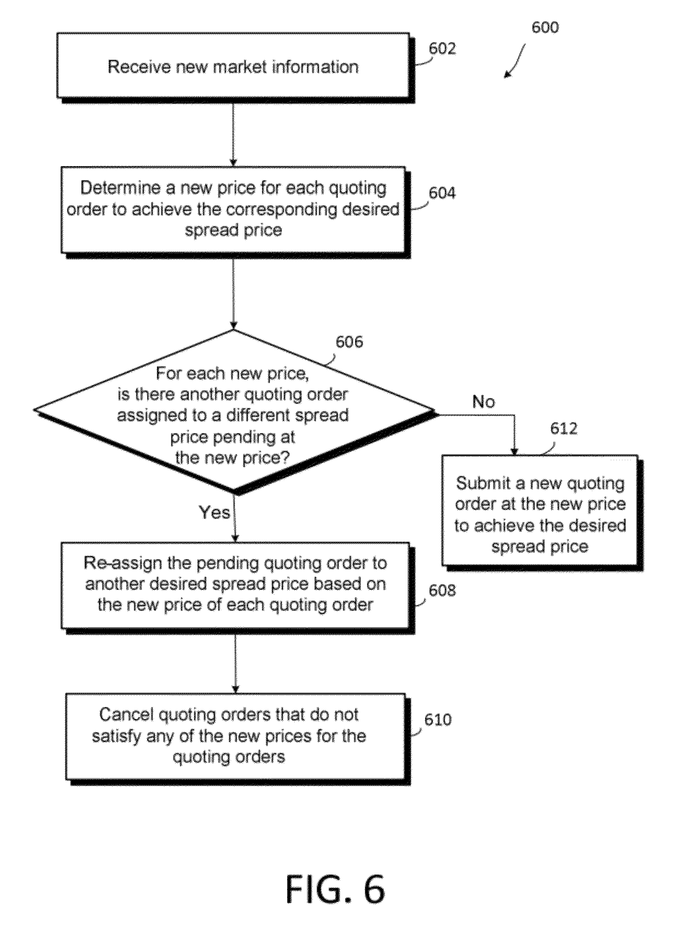

FIG. 6 is a flow diagram illustrating an example method 600 for re-pricing quoting orders of a stacker order according to an example embodiment. The method 600 may be a continuation of the method described in FIG. 5 where a number of quoting orders were placed for and assigned to a plurality of desired spread prices of a spread trading strategy.

At step 602, new market information is received for one or more spread leg orders, such as a tradeable object corresponding to leg 2 in this example. At step 604, the trading tool determines a new price for each quoting order to achieve the desired spread price corresponding to each quoting order based on the new market conditions in leg 2.

At step 606, for each new price, the trading tool determines if there is another quoting order assigned to a different spread price pending at the new price calculated for each quoting order. For example, assume that two quoting orders were entered in leg 1 of the spread trading strategy to work two desired spread prices, with the first quoting order at a first price, and the second quoting order at a second price. Also, assume that the first quoting order is assigned to the first desired spread price, and the second quoting order is assigned to the second desired spread price. Upon receiving new market information, the trading tool may determine a new first price for the first quoting order and a new second price for the second order. Once the new prices are determined, the trading tool may determine if second quoting order is pending at the new first price calculated for the first quoting order, or if the first quoting order is pending at the new second price calculated for the second order.

At step 608, based on each re-calculated price, the trading tool may reassign one or more of the pending quoting orders to a different desired spread price of the spread trading strategy. For example, referring back to the above example, if the second quoting order is pending at the new first price, the second quoting order may be re-assigned to the first desired spread price. Similarly, if more than two quoting orders are submitted for the spread trading strategy, the trading tool may determine if there is a quoting order pending at the new second price for the second quoting order.

At step 610, the trading tool cancels any quoting orders that are pending at price levels that do not satisfy any new prices calculated for the quoting orders. Order cancellations may be accomplished by sending a cancelation request.

Referring back to step 606, if there is no pending order at the new price for one or more quoting orders, one or more new quoting orders may be sent to the electronic exchange to satisfy the desired spread price associated with such quoting orders. According to one example embodiment, if one or more orders are to be canceled, such as explained in relation to step 610, a change request may be sent in relation to such orders to change the existing order that does not satisfy any of the re-calculated prices and to replace it with a new order for the quoting order that requires placement of a new quoting order.

D. Market Depth Order Entry

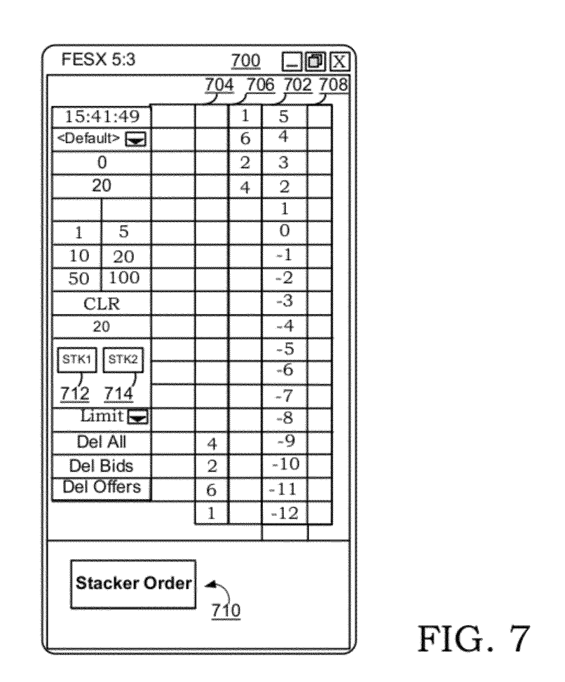

As explained above, an order ticket could be used to enter a stacker order for a spread trading strategy. However, it should be understood that a stacker order could be entered using a trading interface, such as a trading interface 700 of FIG. 7. It should be understood that a stacker order could also be entered using different trading interfaces as well.

The trading interface 700 displays market data related to a spread trading strategy. The trading interface 700 includes a price column 702, a bid quantity column 704, an ask quantity column 706, and a working quantity column 708. The price column 702 includes price levels or some other derivative of price for a spread. The prices or some other derivative of price for the spread may be determined based on market data of the underlying tradeable objects defined for the spread. Once the prices for the spread are calculated, information contained in data feeds for each tradeable object may be used to determine spread data. The calculated data is then used to populate the display against the price column 702. The bid quantity column 704 includes bid quantity indicators. The ask quantity column 706 includes ask quantity indicators. The bid quantity indicator and the ask quantity indicators are aligned with the corresponding price levels of the price column 702 and illustrate how much quantity is available at various price levels. The interface illustrates the inside market that includes the best bid price at “−3” and the lowest ask price at “2.”

The working quantity column 708 illustrates a working buy order indicator 712 having an order quantity of “10” at the price of “−3.” It should be understood that the interface may include additional columns as well, such as a last traded column that may display a last traded price indicator.

The trading interface 700 also shows a stacker order button 710 that can be selected to configure a desired stacker order. Additionally, the interface 700 shows two buttons 712 and 714 corresponding to two pre-configured stacker orders. According to one example embodiment, a user could select one of the stacker order buttons 712 or 714 prior to selecting an order price. Alternatively, rather than selecting one of the buttons, one of the pre-configured order stackers could be activated upon detecting a predetermined user input, such as a trader selecting a specific key on a keyboard. A user could then select a desired price for a stacker order by selecting a location corresponding to a desired price in the bid quantity column 704 or the ask quantity column 706. Further, alternatively, upon selecting one of the buttons 712 or 714, a stacker order may be sent at a price pre-configured for a stacker order associated with the selected button.

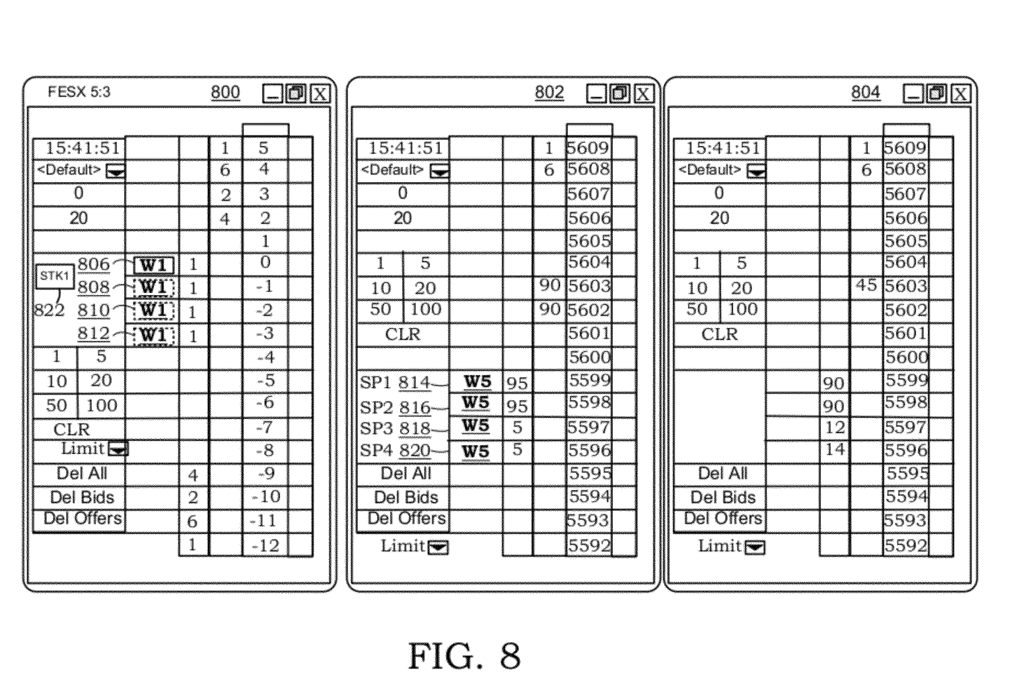

FIG. 8 illustrates three trading interfaces 800, 802, and 804 that will be used to describe a method for placing a stacker order for a spread trading strategy having two legs. In the example embodiment, it is assumed that the market data displayed in the interfaces 802 and 804 correspond to two tradeable objects that underlie the spread trading strategy. Based on the market data of the two tradeable objects, the trading tool may calculate market data for the spread trading strategy, such as the market data illustrated in relation to the interface 800.

It is assumed that a stacker order is pre-configured to have 4 stacker order levels, an offset of “1,” and is used in relation to a spread trading strategy to buy tradeable object “A” and to sell tradeable object “B,” and having a spread ratio of “5:3.” Also, it is assumed that the price selected for the stacker order is a starting price, such that if the stacker order is a buy order, the first desired spread price is at the selected price, and other desired spread prices are below the selected price. Similarly, if the stacker order is a sell order and the selected price is the starting price, the first desired spread price is at the price selected for the stacker order and other desired spread prices are above the selected price. As explained above, various other embodiments could be used to determine desired spread prices when a stacker order is entered.

Referring back to the interface 800, a trader enters a stacker order having an order quantity of “1” and a spread price level of “0,” as shown at 806. Upon detecting that the stacker order is entered, the trading tool identifies four desired spread prices to be worked for the spread trading strategy. In the example provided herein, the desired spread prices are “0,” “4,” “−2,” and “−3,” as shown at 806-812. It should be understood that the four spread prices may be graphically distinguished from other orders displayed on the interface 800 to indicate that the desired spread prices are worked for the trading strategy in connection with the stacker order. Alternatively, a single graphical indicator could be used for the stacker order. In such an embodiment, the indicator could be initially displayed at the highest price (for the buy order) or the lowest price (for the sell order), and the position of the indicator could be updated as each desired spread price is executed. Based on the example stacker order configuration used herein, a single stacker order indicator could be initially displayed at “0.” Then, as the spread at the first desired spread price is executed, the stacker order indicator could be displayed at “1,” and so on.

According to yet another example embodiment, a user could identify all desired spread prices for a stacker order. To do that, a user could enter a stacker order command, such as a predetermined user input, and then select desired spread prices for a stacker order by selecting the prices via the interface 800. The predetermined user input could be detected, for example, upon a user selecting a “STK1” order button 822. Further alternatively, a graphical indicator could be used to identify multiple desired spread prices for a stacker order. For example, an indicator could be movable along the price axis of the interface, and a user could control the size of the indicator to cover the desired spread price levels to be used for a stacker order.

According to yet another example embodiment, a plurality of desired spread prices for a stacker order may be identified by combining two or more existing spread orders at a plurality of spread prices. For example, a user could link the working spread prices to work as a stacker order via a trading interface using an indicator, such as a bracket or line indicator that can displayed in relation to a plurality of prices displayed via the interface. In such an embodiment, a user could extend the indicator across a plurality of working desired spread prices to be linked into a stacker order. It should be understood that many different graphical indicators could be used to enable a trader to select working desired spread prices. Alternatively, a user could enter a stacker order command, such as a predetermined user input, and then select the working spread prices to be linked into a stacker order.

Further alternatively, to identify desired spread price for a stacker order, the trading tool may detect that two or more spread prices are being worked on for a trading strategy. In such an embodiment, the trading tool may automatically link such spread prices to form a stacker order. According to an example embodiment, different criteria could be used to make a determination if the working spread prices should be linked into a stacker order. For example, one criterion may require the working spread prices to be consecutive or at the same offsets, such as every two ticks, for example. It should be understood that different criteria could be used as well. Additionally, a user query may be provided before working spread prices are linked into a stacker order.

As illustrated in FIG. 8, while the trading tool works all four spread prices at the same time, the interface 800 may graphically distinguish the selected price for the stacker order (the solid line square around the working order indicator at the price of “0”), from the spread prices corresponding to the additional levels of the stacker order (a dashed line square around the working order indicators at the prices of “−1,” “−2,” and “−3”). The trading tool may then determine a price level for a quoting order to be submitted in the first leg of the spread based on each desired spread price associated with the stacker order. More specifically, with the best bid corresponding to the second tradeable object at the price level of “5599,”the trading tool calculates the price of “5599” for a first quoting order to achieve the desired spread price of “0.” The trading tool calculates three additional prices of “5598,” “5597,” and “5596” for the three additional quoting orders to achieve the remaining desired spread prices. The quoting orders 814-820 are assigned to each respective desired spread price. Based on the example used in relation to FIG. 8, the quoting order 808 corresponds to the first desired spread price, “SP1,” as illustrated in FIG. 8, the quoting order 810 corresponds to the second desired spread price, “SP2,” etc. For purposes of illustration, FIG. 8 displays “SP1”-“SP4.” However, it should be understood that the labels illustrating the assignment of quoting orders to each desired spread price may be omitted.

As mentioned above, a user could modify a stacker order. According to an example embodiment, the stacker order may be modified by deleting one or more stacker levels. In such an embodiment, a user could enter a delete request in relation to one of the spread prices identified for the stacker order. For example, a user could delete the spread price of “−3” from the stacker order by selecting the indicator 814 with a single user input. Further, alternatively, the stacker order may be modified by deleting one or more quoting orders. For example, the spread price of “−3” could be deleted from the stacker order upon deleting the working quoting order “820.”

As shown in FIG. 8, four quoting orders 814-820 are submitted to buy the first tradeable object. The order quantity of each quoting order is “5” based on the spread ratio and the quantity specified for the stacker order. While FIG. 8 illustrates only the first spread leg being quoted, it should be understood that both legs could be quoted at the same time as well.

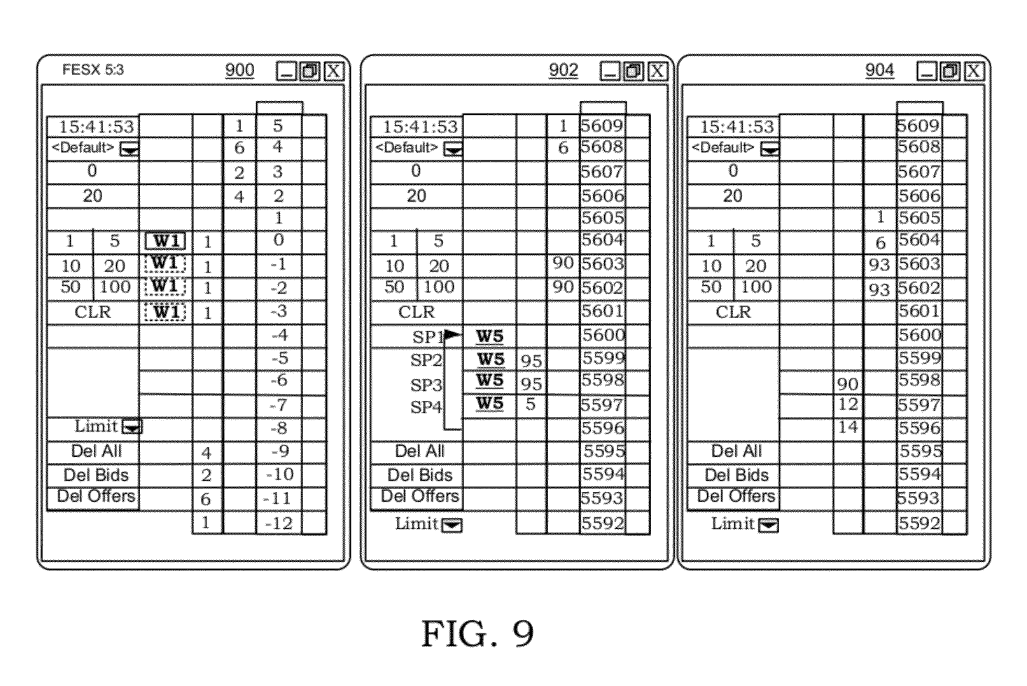

FIG. 9 illustrates the trading interfaces of FIG. 8 at a later time. FIG. 9 illustrates how the pending quoting orders may be re-assigned between the desired spread prices determined for the stacker order upon detecting a change in market conditions of a leaned on leg.

As shown in relation to the interface 904, the market conditions associated with the leaned on leg have changed such that the best bid is now at the price of “5598,” as compared to the previous best bid price of “5599” shown in FIG. 8. Once the market moves, the trading tools application may calculate a new price for each quoting order. The calculated prices are “5600” for the first desired spread price, “5599” for the second desired spread price, “5598” for the third desired spread price, and “5597” for the fourth desired spread price.

Rather than canceling all pending quoting orders and placing a new quoting order to satisfy each desired spread price, the automated trading tool may re-assign the pending quoting orders based on the re-calculated quoting prices for each desired spread price. More specifically, the quoting order at “5599” that was assigned to the first desired spread price may be re-assigned to the second desired spread price, the quoting order at “5598” may be re-assigned to the third desired spread price, and the quoting order at “5597” may be re-assigned to the fourth desired spread price. The new assignment of the quoting orders to the desired spread prices that are worked for the spread is illustrated in FIG. 9. Then, the quoting order at “5596” may be cancelled and a new quoting order at “5600” may be submitted for the first desired spread price. According to another example embodiment, a change request may be submitted in relation to the order at “5596” to re-price the order to “5600.” It should be understood that the command that is actually sent to cancel the existing order and place a new order may be exchange-specific. It should be understood that, based on the market changes, one or more orders could be added at prices above or below the prices of the pending orders, while one or more of the existing orders may be re-assigned to a different desired spread price determined for a stacker order.

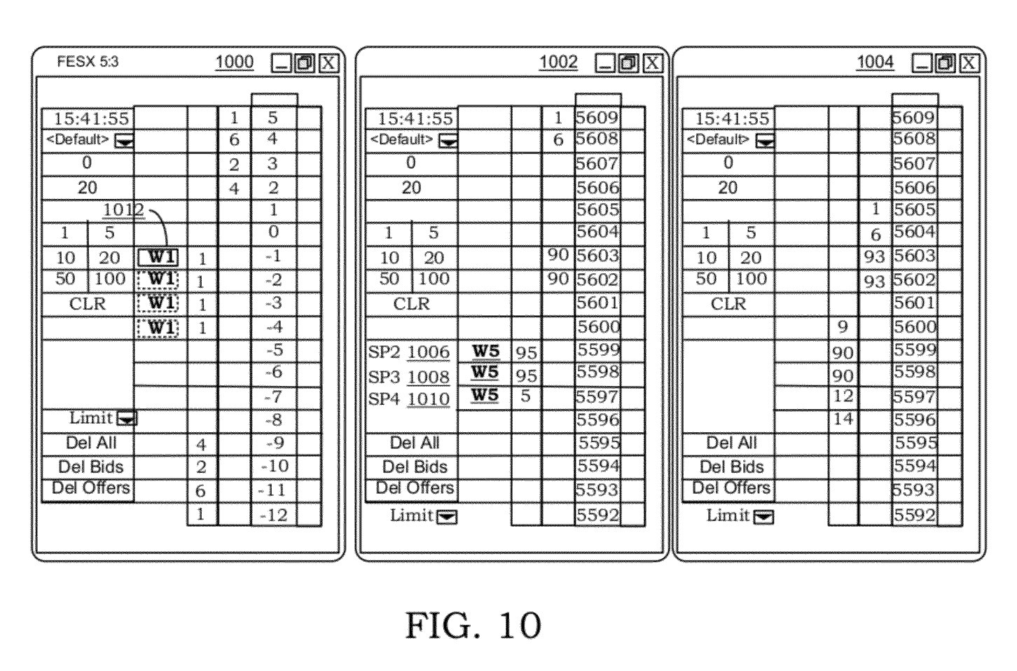

FIG. 10 illustrates the trading interfaces of FIG. 9 at a later time. More specifically, FIG. 10 illustrates a fill detected in relation to one of the quoting orders. More specifically, as shown in relation to the interface 1002, the quoting order at “5600” corresponding to the first desired spread price has been filled. Three remaining orders 1006, 1008, and 1010 are pending for the first leg of the spread and correspond to the second, third, and fourth desired spread prices. Upon detecting the fill, the hedge order may be sent to the leaned on leg. Once the hedge order is filled, the spread at the first desired spread price is executed. The spread price displayed via the interface 1000 may be adjusted to reflect the execution of the spread at the first desired spread price. The interface 1000 shows a spread order indicator 1012 at “−1.”

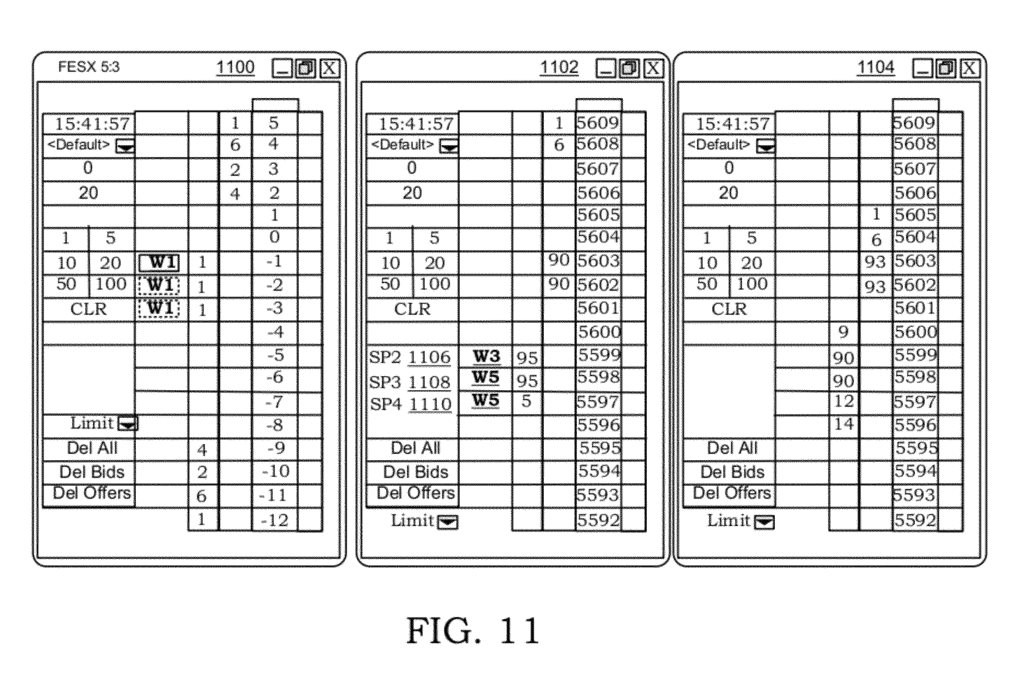

FIG. 11 illustrates the trading interfaces of FIG. 10 at a later time. More specifically, FIG. 11 illustrates a partial fill detected in relation to one of the quoting orders. As shown in relation to the interface 1002, the quoting order 1106 assigned to the second desired spread price is partially filled. While the order quantity of the quoting order 1106 is adjusted to “3” based on the fill, the trading tools application does not adjust the quantities of the remaining quoting orders 1108 and 1110 as they are used in relation to different desired spread prices of the spread trading strategy.

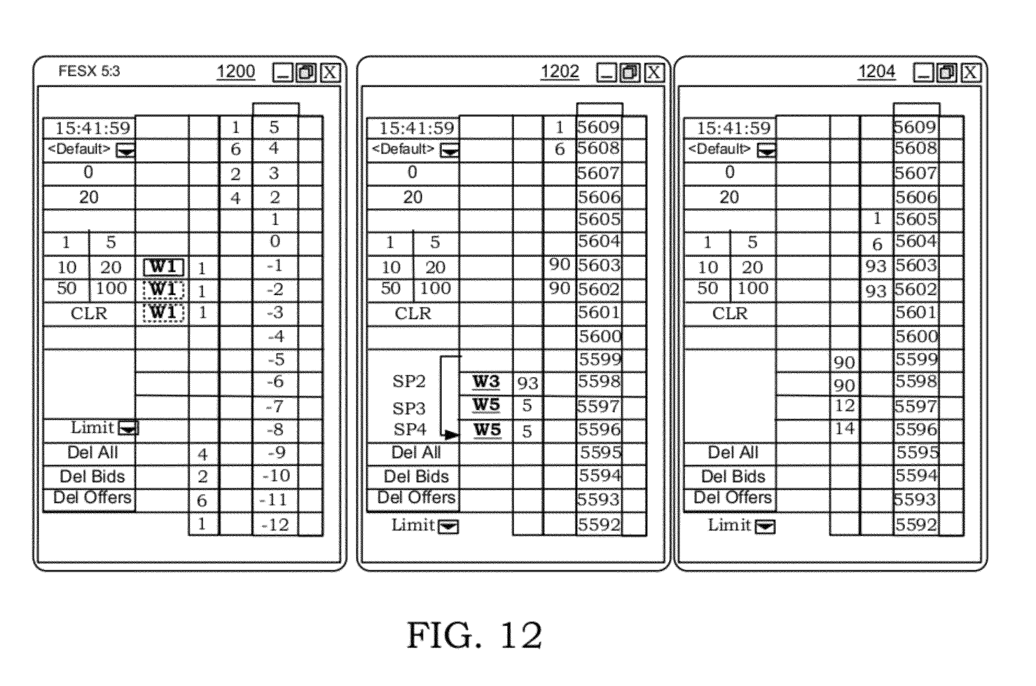

FIG. 12 is a block diagram illustrating the trading interfaces of FIG. 11 at a later time. More specifically, FIG. 12 illustrates quantity adjustment of the pending quoting order upon re-assignment of the order to a different desired spread price. As shown in relation to the interface 1204, the market conditions for the leaned on leg have changed such that the best bid is now at the price of “5599,” as compared to the previous best bid price of “5600,” as was shown in FIG. 11. Once the market moves, the trading tools application may calculate new prices for the quoting orders to satisfy the remaining desired spread prices that are worked for the trading strategy. The calculated prices would be at “5598” for the second desired spread price, “5597” for the third desired spread price, and “5596” for the fourth desired spread price. As shown at the interface 1202, the quoting order at “5598” is re-assigned from the third desired spread price of “−2” to the second desired spread price of “−1.” Because the quoting order that was assigned to the second desired spread price has been partially filled, the quantity of the quoting order at “5598” is adjusted to “3.” Then, the quoting order that was assigned to the second desired spread price at “5599” is re-priced to “5596,” and its quantity is increased from “3” to “5.” The quoting order at “5596” is now assigned to the fourth desired spread price, as shown in FIG. 12.

As explained above, a stacker order provides many benefits. First, it allows a trader to work multiple desired spread prices of a spread by placing a single order. Second, it may improve performance of many trading applications as re-quoting may be minimized by re-assigning the existing quoting orders between different desired spread prices being worked for a spread. By minimizing re-quoting, a trader can potentially avoid transaction fees at exchanges that impose limits on the number of transactions that can be executed by the trader during a trading day. Furthermore, managing the order stacker levels of the quoting orders by reassigning the orders between spread orders of the stacker order allows a trader to maintain a better queue position for the quoting orders as they are re-quoted and filled.

It should be understood that one or more of the steps of the methods discussed above may be implemented alone or in combination in various forms in hardware, firmware, and/or as a set of instructions in software, for example. Certain embodiments may be provided as a set of instructions residing on a computer-readable medium, such as a memory, hard disk, CD-ROM, DVD, and/or EPROM for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for executing a spread trading strategy, comprising:
identifying a plurality of desired spread prices to buy or sell a spread trading strategy;
submitting a quoting order to buy or sell the first tradeable object for each desired spread price, wherein the quoting order is submitted at a price determined based on one of the plurality of desired spread prices;
assigning the plurality of quoting order to the plurality of desired spread prices;
determining that at least a first quoting order corresponding to a first desired spread price of the plurality of desired spread prices is to be re-priced to a first new price based on a change in market conditions of the second tradeable object;
determining that a second quoting order corresponding to a second desired spread price of the plurality of desired spread price is pending at the first new price; and
assigning the second quoting order to the first desired spread price.

2. The method of claim 1, further comprising:
receiving a desired spread price for the spread trading strategy; and, responsively,
identifying the plurality of desired spread prices based on the desired spread price.

3. The method of claim 1, further comprising:
determining a number of price levels to be used for the spread trading strategy; and
determining a number of the plurality of desired spread prices based on the number of order levels.

4. The method of claim 3, wherein the number is user defined.

5. The method of claim 3, wherein the number is based on a formula.

6. The method of claim 1, further comprising:
determining that the second quoting order corresponding to the second desired spread price is to be re-priced to a second new price based on the change in the market conditions of the second tradeable object; and
determining that a third quoting order is not at the second new price; and
submitting a new quoting order at the second new price for the second desired spread price.

7. The method of claim 6, further comprising:
assigning the new quoting order to the second desired spread price.

8. The method of claim 1, further comprising:
defining an offset value to be used in relation to the plurality of desired spread prices of the spread trading strategy; and
using the offset value to determine the plurality of desired spread prices.

9. The method of claim 1, wherein the plurality of desired spread prices are consecutive prices corresponding to the spread trading strategy.

10. The method of claim 1, wherein at least one of the plurality of desired spread prices is not a consecutive price corresponding to the spread trading strategy.

11. The method of claim 1, further comprising:
identifying a plurality of quantities to execute the spread trading strategy at the plurality of desired spread prices, wherein each of the plurality of quantities comprises the same quantity.

12. The method of claim 1, further comprising:
identifying a plurality of quantities to execute the spread trading strategy at the plurality of desired spread prices, wherein at least one of the plurality of quantities is not the same as another quantity of the plurality of quantities.

13. A computer readable medium having stored therein instructions executable by a processor, wherein the instructions are executable to:
identify a plurality of desired spread prices to buy or sell a spread trading strategy;
submitting a quoting order to buy or sell the first tradeable object for each desired spread price, wherein the quoting order is submitted at a price determined based on one of the plurality of desired spread prices;
assign the plurality of quoting order to the plurality of desired spread prices;
determine that at least a first quoting order corresponding to a first desired spread price of the plurality of desired spread prices is to be re-priced to a first new price based on a change in market conditions of the second tradeable object;
determine that a second quoting order corresponding to a second desired spread price of the plurality of desired spread price is pending at the first new price; and
assign the second quoting order to the first desired spread price.

14. The computer readable medium of claim 13, wherein the instructions are further executable to:
receive a desired spread price for the spread trading strategy; and, responsively,
identify the plurality of desired spread prices based on the desired spread price.

15. The computer readable medium of claim 13, wherein the instructions are further executable to
determine a number of price levels to be used for the spread trading strategy; and
determine a number of the plurality of desired spread prices based on the number of order levels.

16. The computer readable medium of claim 15, wherein the number is user defined.

17. The computer readable medium of claim 15, wherein the number is based on a formula.

18. The computer readable medium of claim 13, wherein the instructions are further executable to:
determine that the second quoting order corresponding to the second desired spread price is to be re-priced to a second new price based on the change in the market conditions of the second tradeable object; and
determine that a third quoting order is not at the second new price; and
submit a new quoting order at the second new price for the second desired spread price.

19. The computer readable medium of claim 18, wherein the instructions are further executable to:
assign the new quoting order to the second desired spread price.

20. The computer readable medium of claim 13, wherein the instructions are further executable to:
define an offset value to be used in relation to the plurality of desired spread prices of the plurality of spread orders; and
use the offset value to determine the plurality of desired spread prices.

21. The computer readable medium of claim 13, wherein the plurality of desired spread prices are consecutive prices corresponding to the spread trading strategy.

22. The computer readable medium of claim 13, wherein at least one of the plurality of desired spread prices is not a consecutive price corresponding to the spread trading strategy.

23. The computer readable medium of claim 13, wherein the instructions are further executable to:
identify a plurality of quantities to execute the spread trading strategy at the plurality of desired spread prices, wherein each of the plurality of quantities comprises the same quantity.

24. The computer readable medium of claim 13, wherein the instructions are further executable to:
identify a plurality of quantities to execute the spread trading strategy at the plurality of desired spread prices, wherein at least one of the plurality of quantities is not the same as another quantity of the plurality of quantities.
